(19) United States
(12) Patent Application Publication
(10) Pub. No.: US 2025/0080186 A1
(43) Pub. Date: Mar. 6, 2025

(54) FRAMEWORK AND SIGNALING FOR NON-COHERENT JOINT TRANSMISSION (NCJT) CHANNEL STATE INFORMATION (CSI) SELECTION

(71) Applicant: Telefonaktiebolaget LM Ericsson (publ), Stockholm (SE)

(72) Inventors: Andreas NILSSON, Göteborg (SE); Siva MURUGANATHAN, Stittsville (CA); Shiwei GAO, Nepean (CA)

(21) Appl. No.: 18/559,954

(22) PCT Filed: May 6, 2022
(86) PCT No.: PCT/IB2022/054227

§ 371 Date: Nov. 9, 2023

Related U.S. Application Data
(60) Provisional application No. 63/187,064, filed on May 11, 2021.

(51) Int. Cl. H04B 7/06

(52) U.S. Cl. CPC H04B 7/0626; H04B 7/063; H04B 7/0639; H04B 7/0658

(57) ABSTRACT

A method, system and apparatus for a framework and signaling for non-coherent joint transmission (NCJT) channel state information (CSI) selection are disclosed. According to one aspect, a method in a wireless device (WD) includes performing channel measurements on each of a plurality of channel measurement resources, CMR, associated with each of at least one transmission-and-reception point, TRP. The method also includes transmitting to the network node an indication of at least one of reporting single-TRP channel state information, CSI, and reporting joint-TRP CSI, the CSI reporting being based at least in part on channel measurements on the CMR associated with at least one TRP for which CSI is reported.

### FIELD

The present disclosure relates to wireless communications, and in particular, to a framework and signaling for non-coherent joint transmission (NCJT) channel state information (CSI) selection.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

NR uses CP-OFDM (Cyclic Prefix Orthogonal Frequency Division Multiplexing) in both the downlink (DL) (i.e., from a network node, gNB, or base station, to a user equipment or WD) and the uplink (UL) (i.e., from WD to gNB). Discrete Fourier transform (DFT) spread OFDM is also supported in the uplink. In the time domain, NR downlink and uplink transmissions are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically on a slot basis. An example is shown in FIG. 1 with a 14-symbol slot, where the first two symbols contain physical downlink control channel (PDCCH) and the rest of the symbols contain a physical shared data channel, either a PDSCH (physical downlink shared channel) or a PUSCH (physical uplink shared channel).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot duration at different subcarrier spacings is given by 1/2 μms.

In the frequency domain, a system bandwidth is divided into resource blocks (RBs), each resource block corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

### Beam Management

At millimeter wave (mmW) frequencies, concepts for handling mobility between beams (both within and between transmission reception points (TRPs)) have been specified in NR. At these frequencies, where high-gain beamforming is used, each beam is only optimal within a small area, and the link budget outside the optimal beam deteriorates quickly. Hence, frequent and fast beam switching may be needed to maintain high performance. To support such beam switching, a beam indication framework has been specified in NR. For example, for downlink data transmission (PDSCH), the downlink control information (DCI) contains a transmission configuration indicator (TCI) field that informs the WD which beam is used so that the WD can adjust its receive beam accordingly. This is beneficial for the case of analog receive (Rx) beamforming where the WD needs to determine and apply the Rx beamforming weights before it can receive the PDSCH.

As used here, the terms “spatial filtering weights” or “spatial filtering configuration,” refer to the antenna weights that are applied at either the transmitter (gNB or WD) and the receiver (WD or gNB) for data and control transmission and reception. These terms are more general in the sense that different propagation environments lead to different spatial filtering weights that match the transmission and reception of a signal on the channel. The spatial filtering weights may not always result in a beam in the strict sense.

Prior to data transmission, a training phase is required in order to determine the gNB and WD spatial filtering configurations. An example is illustrated in FIG. 3, and is referred to in NR as DL beam management. In NR, two types of reference signals (RSs) are used for DL beam management operations, the channel state information RS (CSI-RS) and the synchronization signal/physical broadcast control channel (SS/PBCH) block, or SSB for short. FIG. 3 shows an example where CSI-RS is used to find an appropriate beam pair link (BPL), meaning a suitable gNB transmit spatial filtering configuration (gNB transmit (Tx) beam) plus a suitable WD receive spatial filtering configuration (UE Rx beam) resulting in a link budget sufficient to sustain communications.

In particular, FIG. 3 shows a beam training phase followed by a data transmission phase. For downlink data/control transmission, the gNB indicates to the WD that the PDCCH/PDSCH demodulation reference signal (DMRS) is spatially quasi-co-located (QCL) with RS6—the RS on which the WD performs measurements during the WD beam sweep in the beam training phase. At least for uplink control channel transmission, the gNB indicates to the WD that RS6 is the spatial relation for the physical uplink control channel (PUCCH).

In the above example, in the gNB transmit (Tx) beam sweep, the gNB configures the WD to measure on a set of 5 CSI-RS resources (RS1 . . . RS5) which are transmitted with 5 different spatial filtering configurations (Tx beams). The WD is also configured to report back the RS identification (ID) and the reference-signal receive power (RSRP) of the CSI-RS corresponding to the maximum measured RSRP. In this example, the maximum measured RSRP corresponds to RS4. In this way the gNB learns what is the preferred Tx beam from the WD perspective. In the subsequent WD Rx beam sweep, the gNB transmits a number of CSI-RS resources in different OFDM symbols all with the same spatial filtering configuration (Tx beam) as was used to transmit RS4 previously. The WD then tests a different Rx spatial filtering configuration (Rx beam) in each OFDM symbol in order to maximize the received RSRP. The WD remembers the RS ID (RS ID 6 in this example) and the corresponding spatial filtering configuration that results in the largest RSRP. The network, e.g., the network node, can then refer to this RS ID in the future when DL data is scheduled to the WD, thus allowing the WD to adjust its Rx spatial filtering configuration (Rx beam) to receive the PDSCH. As mentioned above, the RS ID is contained in a transmission configuration indicator (TCI) that is carried in a field in the DCI that schedules the PDSCH.

### Channel State Information (CSI) and CSI Feedback

A core component in LTE and NR is the support of multiple input multiple output (MIMO) antenna deployments and MIMO related techniques. Spatial multiplexing is one of the MIMO techniques used to achieve high data rates in favorable channel conditions.

For an antenna array with N_{T} antenna ports at the gNB for transmitting r DL symbols s=[s₁, s₂, . . . , sᵣ]^{T}, the received signal at a WD with N_{R} receive antennas at a certain RE n can be expressed as:

$${y}_{n} = {H}_{n} Ws + {e}_{n}$$

where yₙ is a NR×1 received signal vector; Hₙ is an N_{R}×N_{T} channel matrix at the resource element (RE) between the gNB and the WD; W is an N_{T}×r precoder matrix; and eₙ is a N_{R}×1 noise plus interference vector received at the RE by the WD. The precoder W can be a wideband precoder, i.e., constant over a whole bandwidth part (BWP), or a subband precoder, i.e., constant over each subband.

The precoder matrix is typically selected from a codebook of possible precoder matrices, and typically reported by a precoder matrix indicator (PMI), which specifies a unique precoder matrix in the codebook for a given number of symbol streams. Each of the r symbols in s corresponds to a spatial layer. The value r is referred to as the rank of the channel and is reported by a rank indicator (RI).

For a given block error rate (BLER), a modulation level and coding scheme (MCS) is determined by a WD based on the observed signal to noise and interference ratio (SINR), which is reported by a channel quality indicator (CQI). NR supports transmission of either one or two transport blocks (TBs) to a WD in a slot, depending on the rank. One TB is used for ranks 1 to 4, and two TBs are used for ranks 5 to 8. A CQI is associated with each TB. The CQIRI/PMI report can be either wideband or subband based on configuration.

RI, PMI, and CQI are part of channel state information (CSI) reported by a WD to a network node, e.g., gNB.

### Channel State Information Reference Signal (CSI-RS) and CSI-IM

A CSI-RS is transmitted on each transmit antenna port and is used by a WD to measure downlink channel associated with each of the transmit antenna ports. The antenna ports are also referred to as CSI-RS ports. The supported number of antenna ports in NR are {1, 2, 4, 8, 12, 16, 24, 32}. By measuring the received CSI-RS, a WD can estimate the channel the CSI-RS is traversing, including the radio propagation channel and antenna gains. CSI-RS for this purpose is also referred to as Non-Zero Power (NZP) CSI-RS.

NZP CSI-RS can be configured to be transmitted in certain REs per physical resource block (PRB). FIG. 4 shows an example of a NZP CSI-RS resource configuration with 4 CSI-RS ports in a PRB in one slot.

In addition to NZP CSI-RS, Zero Power (ZP) CSI-RS was defined in NR to indicate to a WD that the associated REs are not available for PDSCH scheduling at the gNB. ZP CSI-RS can have the same RE patterns as NZP CSI-RS.

CSI resources for interference measurement, CSI-IM, is also defined in NR for a WD to measure noise and interference, typically from other cells. CSI-IM has 4 REs in a slot. Two different CSI-IM patterns are defined: The CSI-IM pattern can be either 4 consecutive REs in one OFDM symbol or two consecutive REs in both frequency and time domains. An example is shown in FIG. Typically, the gNB does not transmit any signal in the CSI-IM resource so that what observed in the resource is noise and interference from other cells.

### CSI Framework in NR

In NR, a WD can be configured with one or multiple CSI report configurations. Each CSI report configuration (defined by a higher layer information element (IE), CSI-ReportConfig) is associated with a BWP and contains one or more of:
a CSI resource configuration for channel measurement;
a CSI-IM resource configuration for interference measurement;
a NZP CSI-RS resource for interference measurement;
reporting type, i.e., aperiodic CSI (on PUSCH), periodic CSI (on PUCCH) or semi-persistent CSI (on PUCCH, and DCI activated on PUSCH);
report quantity specifying what to be reported, such as RI, PMI, CQI;
codebook configuration such as type I or type II CSI; and/or
frequency domain configuration, i.e., subband vs. wideband CQI or PMI, and subband size.

The CSI-ReportConfig IE is shown below according to the NR radio resource control (RRC) specification 3GPP Technical Standard (TS) 38.331. Some parameters are omitted.

### CSI-ReportConfig Information Element

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- |

Need R

| | | |
|---|---|---|
| nzp-CSI-RS-ResourcesForInterference | CSI-ResourceConfigId | OPTIONAL, |

-- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1 .. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL |

-- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI |
| } | OPTIONAL, -- Need R |
| pmi-FormatIndicator | ENUMERATED { widebandPMI, |
| subbandPMI } | OPTIONAL, -- Need R |

}

Other parameters are omitted

A WD can be Configured with One or Multiple CSI Resource Configurations each with a CSI-ResourceConfigId, for channel and interference measurement. Each CSI resource configuration for channel measurement or for NZP CSI-RS based interference measurement can contain one or more NZP CSI-RS resource sets. Each NZP CSI-RS resource set, can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. Each CSI-IM resource set can further contain one or more CSI-IM resources. A CSI-IM resource can be periodic, semi-persistent, or aperiodic.

Periodic CSI starts after it has been configured by RRC and is reported on the PUCCH; the associated NZP CSI-RS resource(s) and CSI-IM resource(s) are also periodic.

For semi-persistent CSI, it can be either on the PUCCH or the PUSCH. Semi-persistent CSI on PUCCH is activated or deactivated by a medium access control (MAC) control element (CE) command. Semi-persistent CSI on the PUSCH is activated or deactivated by DCI. The associated NZP CSI-RS resource(s) and CSI-IM resource(s) can be either periodic or semi-persistent.

Aperiodic CSI, is reported on the PUSCH and is activated by a CSI request bit field in DCI. The associated NZP CSI-RS resource(s) and CSI-IM resource(s) can be either periodic, semi-persistent, or aperiodic. The linkage between a code point of the CSI request field and a CSI report configuration is via an aperiodic CSI trigger state. A WD is configured by higher layer signaling with a list of aperiodic CSI trigger states, where each of the trigger states contains an associated CSI report configuration. The CSI request field is used to indicate one of the aperiodic CSI trigger states and thus, one CSI report configuration.

If there is more than one NZP CSI-RS resource set and/or more than one CSI-IM resource set associated with a CSI report configuration, only one NZP CSI-RS resource set and one CSI-IM resource set are selected in the aperiodic CSI trigger state. Thus, each aperiodic CSI report is based on a single NZP CSI-RS resource set and a single CSI-IM resource set.

In case multiple NZP CSI-RS resources are configured in a NZP CSI-RS resource set for channel measurement, the WD would select one NZP CSI-RS resource and report a CSI associated with selected NZP CSI-RS resource. A CRI (CSI-RS resource indicator) would be reported as part of the CSI. In this case, the same number of CSI-IM resources, each paired with a NZP CSI-RS resource need to be configured in the associated CSI-IM resource set. That is, when a WD reports a CRI value k, this corresponds to the (k+1)th entry of the NZP CSI-RS resource set for channel measurement, and, if configured, the (k+1)th entry of the CSI-IM resource set for interference measurement (e.g., see clause 5.2.1.4.2 of 3GPP TS 38.214).

When NZP CSI-RS resource(s) are configured for interference measurement in a CSI-ReportConfig IE, only a single NZP-CSI-RS resource in a CSI-RS resource set can be configured for channel measurement in the same CSI-ReportConfig IE.

### Quasi-Co-Location (QCL)

Since the TRPs may be in different physical locations, the propagation channels to the WD can also be different. Different antennas or transmit beams are used in different TRPs. At the WD, different receive antennas or receive beams may be used to receive from different TRPs. To facilitate receiving the PDSCH from different TRPs, TCI (transmission configuration indicator) states were introduced in NR 3GPP Release 15 (3GPP Rel-15).

A TCI state contains Quasi Co-location (QCL) information between a Demodulation Reference Signal (DMRS) for PDCCH or PDSCH and one or two DL reference signals such as a CSI-RS or a SSB. The supported QCL information types in NR are:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}

The QCL information is used by a WD to apply one or more channel properties estimated from the DL reference signals (CSI-RS or SSB) to channel estimation based on the DMRS for the PDSCH or PDCCH reception. For example, channel delay spread and Doppler shift parameters can be estimated from the QCL source RS, the estimation is then used for determining the channel filtering parameters for channel estimation based on the DMRS.

### Non-Coherent Joint Transmission (NC-JT)

In NR 3GPP Rel-15, only the PDSCH transmission from a single Transmission and Reception Point (TRP) is supported, in which a WD receives PDSCH from a single TRP at any given time.

In NR 3GPP Rel-16, PDSCH transmission over multiple TRPs was introduced. One of the multi-TRP schemes is NC-JT, in which a PDSCH to a WD is transmitted over two TRPs with different MIMO layers of the PDSCH transmitted from different TRPs. For example, 2 layers can be transmitted from a first TRP and 1 layer can be transmitted from a second TRP.

NC-JT refers to MIMO data transmission over multiple TRPs in which different MIMO layers are sent over different TRPs. An example is shown in FIG. 5, which shows a PDSCH being sent to a WD over two TRPs, each carrying one code word. When the WD has 4 receive antennas while each of the TRPs has only 2 transmit antennas, the WD can support up to 4 MIMO layers but there are a maximum of 2 MIMO layers from each TRP. In this case, by transmitting data over two TRPs to the WD, the peak data rate to the WD can be increased because up to 4 aggregated layers from the two TRPs can be used. This is beneficial when the traffic load, and thus the resource utilization, is low in each TRP. The scheme can also be beneficial in the case where the WD is in line of sight (LOS) of both the TRPs and the rank per TRP is limited even when there are more transmit antennas available at each TRP.

This type of NC-JT is supported in LTE with two TRPs, each up to 8 antenna ports. For CSI feedback purpose, a WD is configured with a CSI process with two NZP CSI-RS resources, one for each TRP, and one interference measurement resource. The WD may report one of the following scenarios:
1) A WD reports CRI=0, which indicate that CSI is calculated and reported only for the first NZP CSI-RS resource, i.e., a RI, a PMI and a CQI associated with the first NZP CSI-RS resource. This is the case when the WD sees best throughput is achieved by transmitting a PDSCH over the TRP or beam associated with the first NZP CSI-RS resource;
2) A WD reports CRI=1, which indicate that CSI is calculated and reported only for the second NZP CSI-RS resource, i.e., a RI, a PMI and a CQI associated with the second NZP CSI-RS resource. This is the case when the WD sees best throughput is achieved by transmitting a PDSCH over the TRP or beam associated with the second NZP CSI-RS resource; or
3) A WD reports CRI=2, which indicate both of the two NZP CSI-RS resources are calculated and reported. In this case, two set of CSIs, one for each codeword (CW), are calculated and reported based on the two NZP CSI-RS resources and by considering inter-CW interference caused by the other CW. The combinations of reported RIs are restricted such that |RI1−RI2|<=1, where RI1 and RI2 correspond to ranks associated with the 1st and the 2nd NXP CSI-RS, respectively.

In NR 3GPP Rel-16, a different approach is adopted where a single CW is transmitted across two TRPs. An example is shown in FIG. 6, where one layer is transmitted from each of two TRPs.

Two types of NC-JT are supported, i.e., single DCI based N-JT and multi-DCI based NC-JT. In single DCI based NC-JT, it is assumed that a single scheduler is used to schedule data transmission over multiple TRPs; different layers of a single PDSCH scheduled by a single PDCCH can be transmitted from different TRPs

In multi-DCI based NC-JT, independent schedulers are assumed in different TRPs to schedule PDSCHs to a WD. Two PDSCHs scheduled from two TRPs may be fully or partially overlapped in time and frequency resource. Only semi-static coordination between TRPs may be possible

### NC-JT CSI in 3GPP Rel-17

It has been considered in 3GPP RANI that, for CSI measurement associated with a CSI reporting setting, CSI-ReportConfig, for NC-JT, there will be:
Ks≥2 NZP CSI-RS resources in a CSI-RS resource set for channel measurement; the Ks resources will be referred to as channel measurement resources (CMR); and
Within the Ks channel measurement resources (CMRs), N≥1 NZP CSI-RS resource pairs for NC-JT CSI whereas each pair is used for a NC-JT CSI measurement hypothesis.

A measurement hypothesis may specify, for example, which channel measurement reference signals and which interference reference signals are to be used by the WD to perform the channel and interference measurements. Also, the measurement metric to be used by the WD to determine a measure of the channel and interference may be included in the measurement hypothesis.

In addition, the Ks≥2 NZP CSI-RS resources in the CSI-RS resource set for CMR can be divided in to two different CMR groups. Each of the N pairs used for NC-JT CSI measurement hypotheses could be associated with one CMR from each of the two CMR groups.

Furthermore, higher-layer signaling can be used to configure the N CMR pairs. How this signaling is performed has been selected for further study (FFS). Also, whether using higher layer signaling to dynamically indicate CMR pairs for NCJT measurement hypothesis and/or dynamically indicating CMRs for sTRP measurement hypothesis is still to be determined. In addition, whether a CMR used for sTRP measurement hypothesis also can be re-used for a NCJT measurement hypothesis for both FR1 and FR2, or only for FR1 is to be further determined.

The total number of CMRs (Ks) in a NZP CSI-RS resource set used for NCJT CSI reporting can be up to 8 (based on WD capability reporting) and the number of CMRs belonging to each CMR group can be any number as long as K1+K2=Ks, where K1 and K2 are the number of CMRs in the first and second CMR groups, respectively. The maximum number of CMR pairs used for NCJT measurement hypothesis is equal to 2, i.e., Nmax=2.

In terms of CSI reporting associated with the CSI reporting setting, two options are supported. In Option 1, a WD reports one CSI for NC-JT hypothesis and X (X=0,1,2) CSIs for sTRP hypotheses. In Option 2, a WD reports one best CSI among NCJT and sTRP hypotheses. The WD can be configured with either Option 1 or Option 2.

For Option 1, the CSI report has X+1 CRIs, where X CRIs are associated with sTRP measurement hypotheses and one CRI is associated with NCJT measurement hypotheses. Each CRI bit size depends on the corresponding number of either valid CMR pairs for NCJT measurement hypothesis or valid CMRs for single-TRP measurement hypotheses.

The CSI report is divided into two parts (Part 1 and Part 2), where Part 1 is fixed in size while Part 2 varies in size based on what is indicated in Part 1. Part1 contains CRI, RI, wideband CQI and subband CQI for the first codeword (CW) and zero padding (if needed). The rests of CSI are contained in Part 2.

For a NCJT hypothesis, four possible RI combinations, i.e., {RI1, RI2}={1, 1}, {1, 2}, {2,1}, {2,2}, will be reported.

With two parts of CSI reporting on the PUSCH, if the CSI cannot fit in a scheduled UL resource, some parts in Part 2 may be dropped or omitted according to 3GPP TS38.214 v16.5.0 section 5.2.3. For two parts CSI associated with a CSI report setting for both NC-JT and sTRP hypotheses, two alternatives were proposed, i.e.:
Alt. 1: Prioritize CSI with different measurement hypotheses within the single CSI report, when the WD is configured with CSI Option 1 with X=1 or 2; or
Alt. 2; Omission of NCJT CSI in CSI part 2 depending on the corresponding CRI or RI or CQI in CSI part 1.

However, the details are still to be defined. More specifically, how to determine the priority levels between sTRP CSI and NC-JT CSI, and also between two sTRP CSIs if X=2 is an issue.

Another issue is that when CSI for the NCJT measurement hypothesis is omitted in the CSI report (in order to save overhead), how to indicate the omission to the network node, e.g., gNB is not yet resolved.

### SUMMARY

Some embodiments advantageously provide methods, systems, and apparatuses for a framework and signaling for non-coherent joint transmission (NCJT) channel state information (CSI) selection. By enabling support to let the WD omit CSI for NCJT measurement hypotheses, unnecessary CSI reporting overhead can be removed.

According to one aspect, a method in a network node configured to communicate with a wireless device, WD, is provided. The method includes: configuring the WD for at least one of single transmission-and-reception point, TRP, channel state information, CSI, reporting and joint TRP CSI reporting, the CSI reporting being based at least in part on channel measurements measured on channel measurement resources, CMR, associated with each of at least one TRP; and receiving from the WD an indication of one of single-TRP CSI reporting and joint-TRP CSI reporting.

According to this aspect, in some embodiments, the indication is included in a channel resource indicator, CRI, field configured to indicate for which of at least one TRP, CSI is reported. In some embodiments, the CRI field is configured to indicate omission of joint CSI reporting for at least one of a plurality of TRPs. In some embodiments, the indication is included in a rank indicator field including bits reserved for single and joint CSI reporting rank indications. In some embodiments, configuring the WD includes indicating a first rank for single CSI reporting and a second rank for joint CSI reporting.

According to another aspect, a network node configured to communicate with a wireless device, WD, is provided. The network node includes processing circuitry configured to configure the WD for at least one of single transmission-and-reception point, TRP, channel state information, CSI, reporting and joint TRP CSI reporting, the CSI reporting being based at least in part on channel measurements measured on channel measurement resources, CMR, associated with each of at least one TRP. The network node includes a radio interface in communication with the processing circuitry and configured to receive from the WD an indication of one of single-TRP CSI reporting and joint-TRP CSI reporting.

According to this aspect, in some embodiments, the indication is included in a channel resource indicator, CRI, field configured to indicate for which of at least one TRP, CSI is reported. In some embodiments, the CRI field is configured to indicate omission of joint CSI reporting for at least one of a plurality of TRPs. In some embodiments, the indication is included in a rank indicator field including bits reserved for single and joint CSI reporting rank indications. In some embodiments, configuring the WD includes indicating a first rank for single CSI reporting and a second rank for joint CSI reporting.

According to yet another aspect, a method in a wireless device, WD, configured to communicate with a network node, is provided. The method includes performing channel measurements on each of a plurality of channel measurement resources, CMR, associated with each of at least one transmission-and-reception point, TRP. The method also includes transmitting to the network node an indication of at least one of reporting single-TRP channel state information, CSI, and reporting joint-TRP CSI, the CSI reporting being based at least in part on channel measurements on the CMR associated with at least one TRP for which CSI is reported.

According to this aspect, in some embodiments, the indication is included in a channel resource indicator, CRI, field configured to indicate for which of at least one TRP, CSI is reported. In some embodiments, the CRI field is configured to indicate omission of joint-TRP CSI reporting for at least one of a plurality of TRPs. In some embodiments, a CSI report includes a first part and a second part, the first part of the CSI report indicating for which CMR the CSI is reported, the second part of the CSI report reporting CSI for the indicated CMR. In some embodiments, the first part of the CSI report includes a first field to indicate for which CMR the single-TRP CSI is reported and a second field to indicate for which CMR joint-TRP CSI is reported. In some embodiments, the second field includes at least one codepoint reserved to indicate inclusion of CSI reporting of at least one of a set of joint-TRP CSI. In some embodiments, the second field includes at least one codepoint reserved to indicate omission of CSI reporting of at least one of a set of joint-TRP CSI. In some embodiments, the indication is included in a rank indicator field including bits reserved for reporting rank indications for single-TRP CSI reporting and joint-TRP CSI reporting. In some embodiments, a first rank is indicated for single-TRP CSI reporting and a second rank is indicated for joint-TRP CSI reporting. In some embodiments, joint-TRP CSI reporting is omitted when a rank indication exceeds a rank threshold.

According to yet another aspect, a WD, configured to communicate with a network node, the wireless device is provided. The WD includes a radio interface configured to: perform channel measurements on each of a plurality of channel measurement resources, CMR, associated with each of at least one transmission-and-reception point, TRP. The radio interface is further configured to transmit to the network node an indication of at least one of reporting single-TRP channel state information, CSI, and reporting joint-TRP CSI, the CSI reporting being based at least in part on channel measurements on the CMR associated with at least one TRP for which CSI is reported.

According to this aspect, in some embodiments, the indication is included in a channel resource indicator, CRI, field configured to indicate for which of at least one TRP, CSI is reported. In some embodiments, the CRI field is configured to indicate omission of joint-TRP CSI reporting for at least one of a plurality of TRPs. In some embodiments, a CSI report includes a first part and a second part, the first part of the CSI report indicating for which CMR the CSI is reported, the second part of the CSI report reporting CSI for the indicated CMR. In some embodiments, the first part of the CSI report includes a first field to indicate for which CMR the single-TRP CSI is reported and a second field to indicate for which CMR joint-TRP CSI is reported. In some embodiments, the second field includes at least one codepoint reserved to indicate inclusion of CSI reporting of at least one of a set of joint-TRP CSI. In some embodiments, the second field includes at least one codepoint reserved to indicate omission of CSI reporting of at least one of a set of joint-TRP CSI. In some embodiments, the indication is included in a rank indicator field including bits reserved for reporting rank indications for single-TRP CSI reporting and joint-TRP CSI reporting. In some embodiments, a first rank is indicated for single-TRP CSI reporting and a second rank is indicated for joint-TRP CSI reporting. In some embodiments, joint-TRP CSI reporting is omitted when a rank indication exceeds a rank threshold.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of an NR slot;

FIG. 2 illustrates a time-frequency resource grid;

FIG. 3 illustrates downlink beam management;

FIG. 4 is an example of an NZP CSI-RS resource configuration;

FIG. 5 illustrates sending PDSCH messages to a WD;

FIG. 6 illustrates transmitting a single CW across two TRPs;

FIG. 7 is a schematic diagram of an example network architecture illustrating a communication system connected via an intermediate network to a host computer according to the principles in the present disclosure;

FIG. 8 is a block diagram of a host computer communicating via a network node with a wireless device over an at least partially wireless connection according to some embodiments of the present disclosure;

FIG. 9 is a flowchart illustrating example methods implemented in a communication system including a host computer, a network node and a wireless device for executing a client application at a wireless device according to some embodiments of the present disclosure;

FIG. 10 is a flowchart illustrating example methods implemented in a communication system including a host computer, a network node and a wireless device for receiving user data at a wireless device according to some embodiments of the present disclosure;

FIG. 11 is a flowchart illustrating example methods implemented in a communication system including a host computer, a network node and a wireless device for receiving user data from the wireless device at a host computer according to some embodiments of the present disclosure;

FIG. 12 is a flowchart illustrating example methods implemented in a communication system including a host computer, a network node and a wireless device for receiving user data at a host computer according to some embodiments of the present disclosure;

FIG. 13 is a flowchart of an example process in a network node for a framework and signaling for non-coherent joint transmission (NCJT) channel state information (CSI) selection;

FIG. 14 is a flowchart of an example process in a wireless device for a framework and signaling for non-coherent joint transmission (NCJT) channel state information (CSI) selection;

FIG. 15 is a flowchart of an example process in a network node for a framework and signaling for non-coherent joint transmission (NCJT) channel state information (CSI) selection; and

FIG. 16 is a flowchart of an example process in a wireless device for a framework and signaling for non-coherent joint transmission (NCJT) channel state information (CSI) selection.

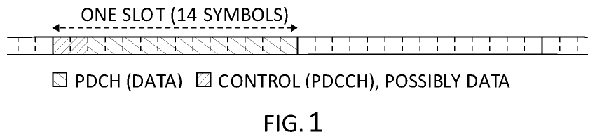

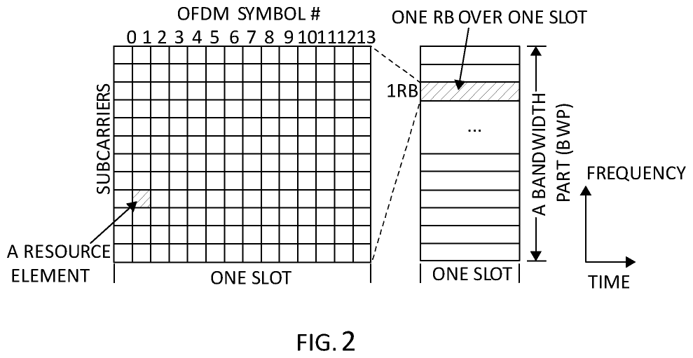

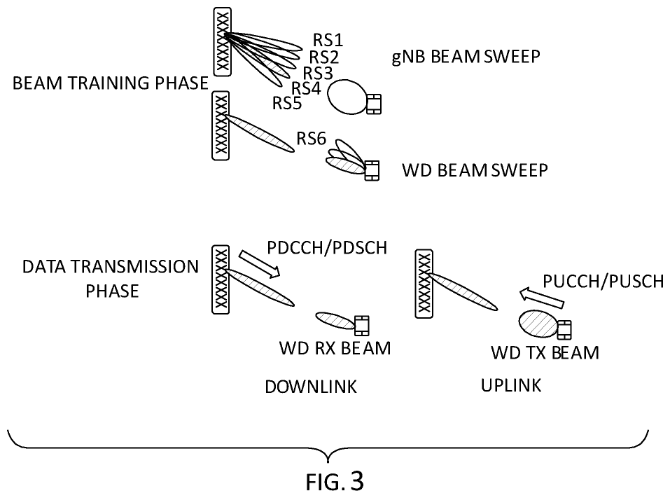

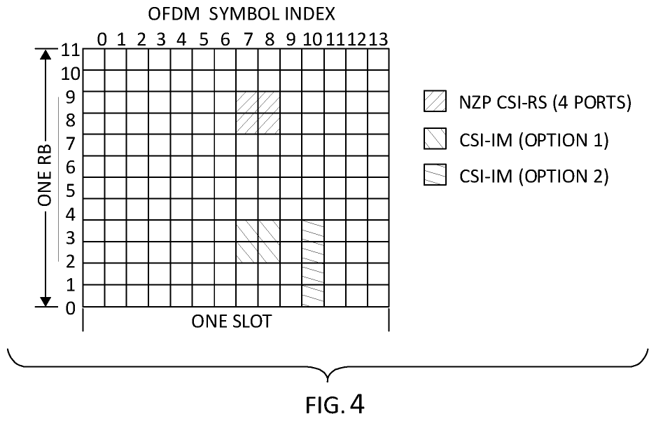

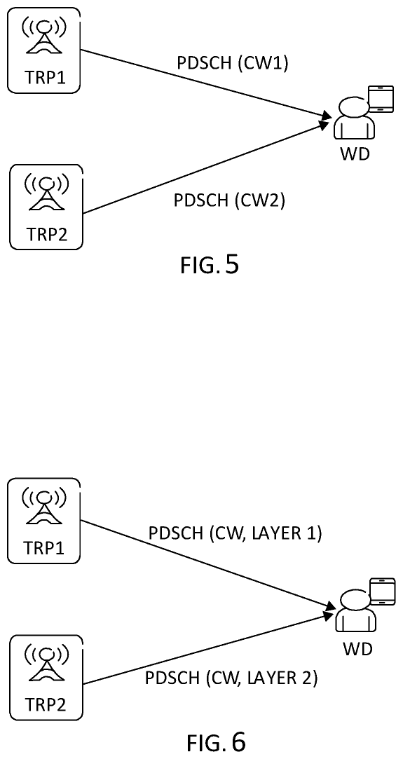

### DETAILED DESCRIPTION

Before describing in detail example embodiments, it is noted that the embodiments reside primarily in combinations of apparatus components and processing steps related to a framework and signaling for non-coherent joint transmission (NCJT) channel state information (CSI) selection. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD).

In some embodiments, the non-limiting terms wireless device (WD) or a user equipment (UE) are used interchangeably. The WD herein can be any type of wireless device capable of communicating with a network node or another WD over radio signals. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

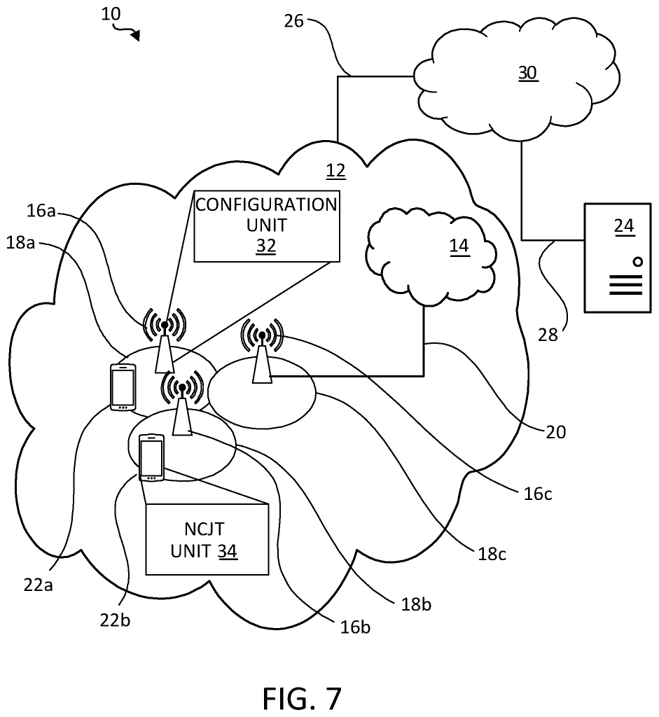

Some embodiments provide a framework and signaling for non-coherent joint transmission (NCJT) channel state information (CSI) selection. Returning now to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure the WD for at least one of single transmission-and-reception point. TRP, channel state information, CSI, reporting and joint TRP CSI reporting, the CSI reporting being based at least in part on channel measurements measured on channel measurement resources, CMR, associated with each of at least one TRP A wireless device 22 is configured to transmit to the network node an indication of at least one of reporting single-TRP channel state information, CSI, and reporting joint-TRP CSI, the CSI reporting being based at least in part on channel measurements on the CMR associated with at least one TRP for which CSI is reported.

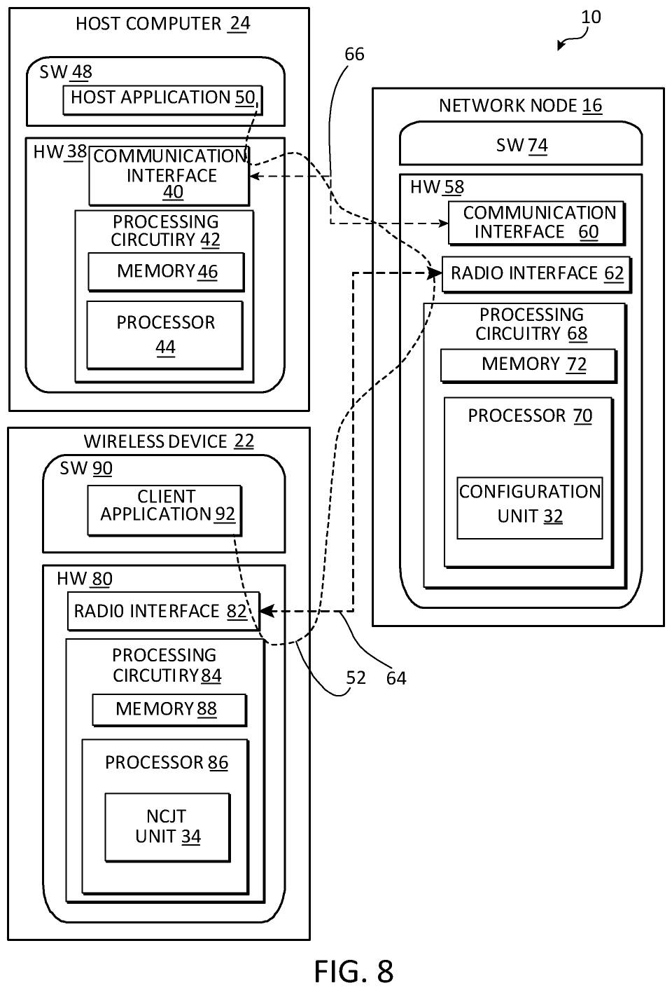

Example implementations, in accordance with an embodiment, of the WD 22, network node 16 and host computer 24 discussed in the preceding paragraphs will now be described with reference to FIG. 8. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure the WD for at least one of single transmission-and-reception point. TRP, channel state information, CSI, reporting and joint TRP CSI reporting, the CSI reporting being based at least in part on channel measurements measured on channel measurement resources, CMR, associated with each of at least one TRP.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an NCJT unit 34 which is configured to transmit to the network node an indication of at least one of reporting single-TRP channel state information, CSI, and reporting joint-TRP CSI, the CSI reporting being based at least in part on channel measurements on the CMR associated with at least one TRP for which CSI is reported

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing considerations or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for

preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as xxx unit 32, and xxx unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

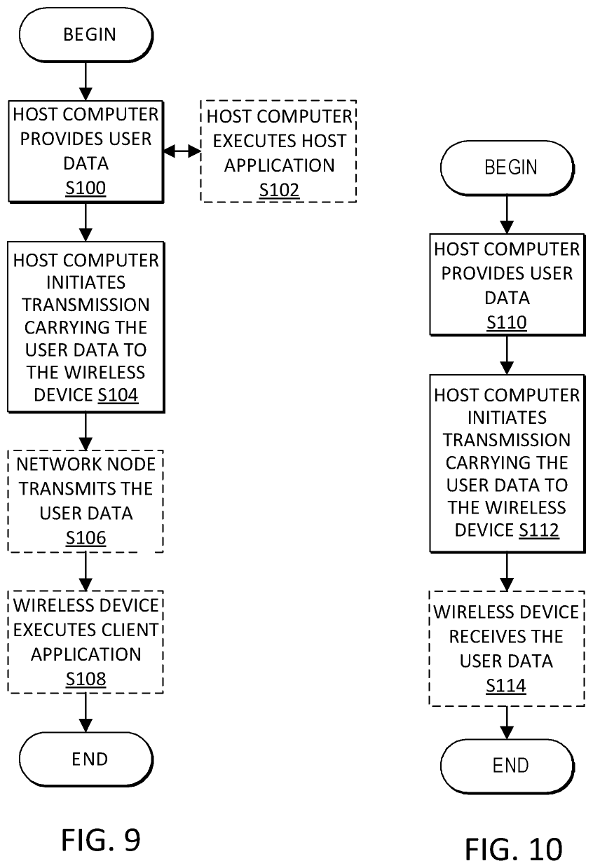

FIG. 9 is a flowchart illustrating an example method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 10 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

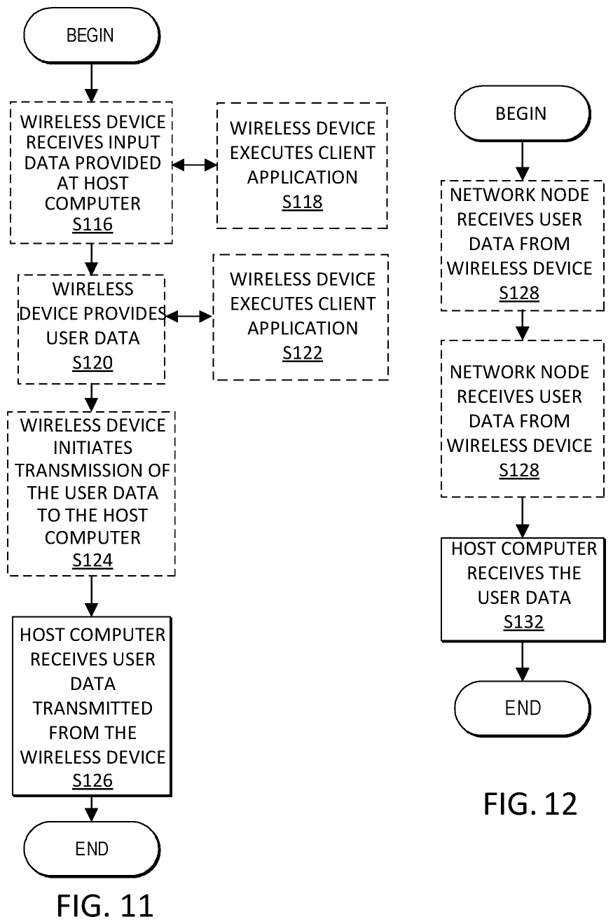

FIG. 11 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

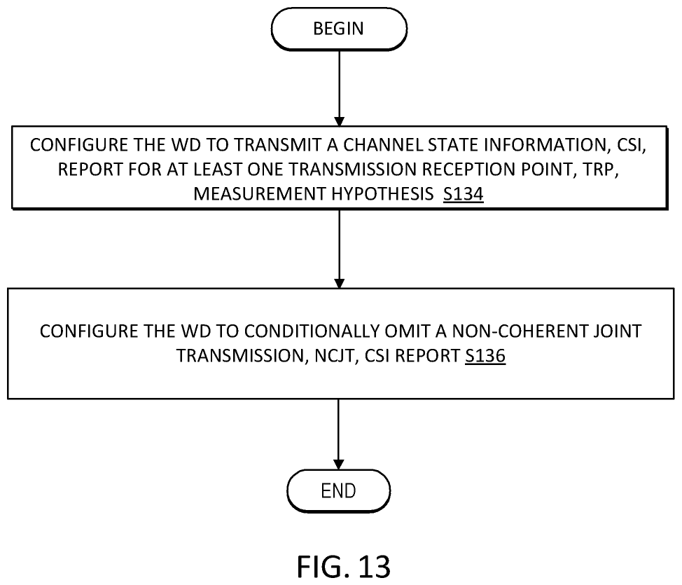

FIG. 13 is a flowchart of an example process in a network node 16 for a framework and signaling for non-coherent joint transmission (NCJT) channel state information (CSI) selection. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the WD to transmit a channel state information, CSI, report for at least one transmission reception point, TRP, measurement hypothesis (Block S134). The process also includes configuring the WD to conditionally omit a non-coherent joint transmission, NCJT, CSI report (Block S136).

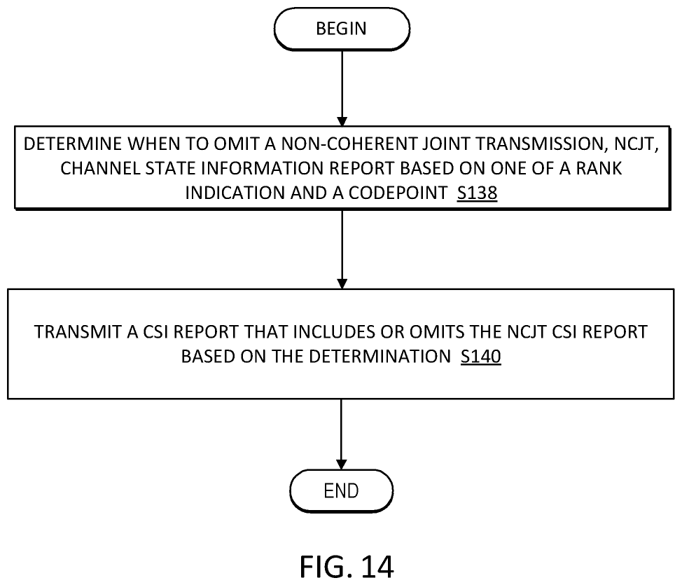

FIG. 14 is a flowchart of an example process in a wireless device 22 according to some embodiments of the present disclosure. One or more blocks described herein may be performed by one or more elements of wireless device 22 such as by one or more of processing circuitry 84 (including the NCJT unit 34), processor 86, radio interface 82 and/or communication interface 60. Wireless device 22 such as via processing circuitry 84 and/or processor 86 and/or radio interface 82 is configured to determine when to omit a non-coherent joint transmission, NCJT, channel state information report based on one of a rank indication and a codepoint (Block S138). The process also includes transmitting a CSI report that includes or omits the NCJT CSI report based on the determination (Block S140).

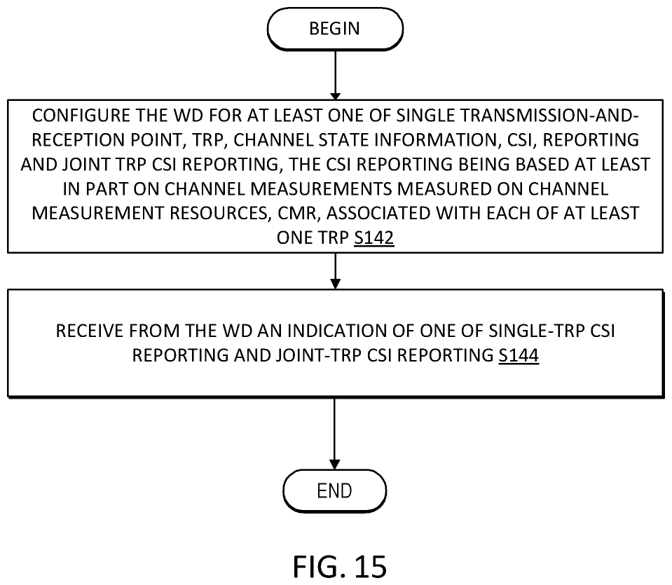

FIG. 15 is a flowchart of an example process in a network node 16 for a framework and signaling for non-coherent joint transmission (NCJT) channel state information (CSI) selection. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the WD for at least one of single transmission-and-reception point, TRP, channel state information, CSI, reporting and joint TRP CSI reporting, the CSI reporting being based at least in part on channel measurements measured on channel measurement resources, CMR, associated with each of at least one TRP (Block S142) and receiving from the WD an indication of one of single-TRP CSI reporting and joint-TRP CSI reporting (Block S144).

In some embodiments, the indication is included in a channel resource indicator, CRI, field configured to indicate for which of at least one TRP, CSI is reported. In some embodiments, the CRI field is configured to indicate omission of joint CSI reporting for at least one of a plurality of TRPs. In some embodiments, the indication is included in a rank indicator field including bits reserved for single and joint CSI reporting rank indications. In some embodiments, configuring the WD includes indicating a first rank for single CSI reporting and a second rank for joint CSI reporting.

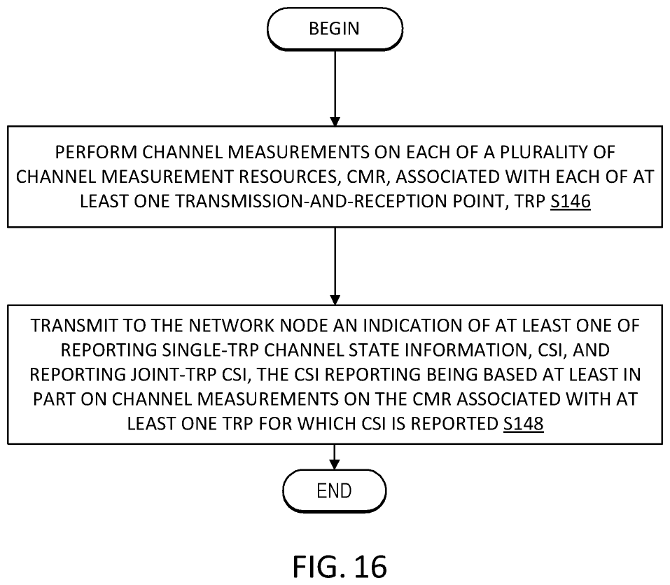

FIG. 16 is a flowchart of an example process in a wireless device 22 according to some embodiments of the present disclosure. One or more blocks described herein may be performed by one or more elements of wireless device 22 such as by one or more of processing circuitry 84 (including the NCJT unit 34), processor 86, radio interface 82 and/or communication interface 60. Wireless device 22 such as via processing circuitry 84 and/or processor 86 and/or radio interface 82 is configured to perform channel measurements on each of a plurality of channel measurement resources, CMR, associated with each of at least one transmission-and-reception point, TRP (Block S146). The method also includes transmitting to the network node an indication of at least one of reporting single-TRP channel state information, CSI, and reporting joint-TRP CSI, the CSI reporting being based at least in part on channel measurements on the CMR associated with at least one TRP for which CSI is reported (Block S148).

In some embodiments, the indication is included in a channel resource indicator, CRI, field configured to indicate for which of at least one TRP, CSI is reported. In some embodiments, the CRI field is configured to indicate omission of joint-TRP CSI reporting for at least one of a plurality of TRPs. In some embodiments, a CSI report includes a first part and a second part, the first part of the CSI report indicating for which CMR the CSI is reported, the second part of the CSI report reporting CSI for the indicated CMR. In some embodiments, the first part of the CSI report includes a first field to indicate for which CMR the single-TRP CSI is reported and a second field to indicate for which CMR joint-TRP CSI is reported. In some embodiments, the second field includes at least one codepoint reserved to indicate inclusion of CSI reporting of at least one of a set of joint-TRP CSI. In some embodiments, the second field includes at least one codepoint reserved to indicate omission of CSI reporting of at least one of a set of joint-TRP CSI. In some embodiments, the indication is included in a rank indicator field including bits reserved for reporting rank indications for single-TRP CSI reporting and joint-TRP CSI reporting. In some embodiments, a first rank is indicated for single-TRP CSI reporting and a second rank is indicated for joint-TRP CSI reporting. In some embodiments, joint-TRP CSI reporting is omitted when a rank indication exceeds a rank threshold.

Having described the general process flow of arrangements of the disclosure and having provided examples of hardware and software arrangements for implementing the processes and functions of the disclosure, the sections below provide details and examples of arrangements for a framework and signaling for non-coherent joint transmission (NCJT) channel state information (CSI) selection.

Even though the terms sTRP CSI and NC-JT CSI are used in this disclosure, these terms may not necessarily be used in the 3GPP specifications, which may use different terms for these CSI.

In some embodiments, sTRP CSI may be represented by a CSI calculated based at least in part on channel measurements performed on a single NZP CSI-RS resource. The TRP for which the sTRP CSI corresponds to transmits a NZP CSI-RS in this NZP CSI-RS resource. In addition, interference measurement to be used in this CSI calculation may also be performed on an interference measurement resource. The sTRP CSI has an RI, PMI, and CQI (wideband and/or subband CQI). In some embodiments, the sTRP CSI may also have a CSI-RS resource indicator (CRI), where the CRI indicates a NZP CSI-RS resource among a set or group of NZP CSI-RS resources to which the sTRP CSI corresponds to. In addition, a layer indicator (LI) may also be fed back as part of the sTRP CSI to indicate which column of the precoder matrix of the reported PMI corresponds to the strongest layer of the codeword corresponding to the largest reported wideband CQI.

In some embodiments, NC-JT CSI may be represented by a CSI calculated based at least in part on channel measurements performed on a pair of NZP CSI-RS resources. The two TRPs for the NC-JT CSI correspond, transmit a NZP CSI-RS in the respective NZP CSI-RS resources. The pair of NZP CSI-RS resources used for channel measurement may be from different channel measurement resource groups. The NC-JT CSI has a pair of RIs, a pair of PMIs, and joint CQI (wideband and/or subband CQI). In some embodiments, the NC-JT CSI may also include a pair of CRIs. In some embodiments, the CRIs may indicate a pair of NZP CSI-RS resources belonging to two different channel measurement groups or NZP CSI-RS resource groups. In some other embodiments, the pair of CRIs may be signaled to the UE from the network node (via RRC and/or medium access control (MAC) control element (CE)). In addition, a pair of layer indicators (Lis) may also be fed back as part of the NC-JT CSI. The first LI in the pair of LIs indicates which column of the precoder matrix of the first reported PMI of the NC-JT CSI corresponds to the strongest layer. The second LI in the pair of LIs indicates which column of the precoder matrix of the second reported PMI of the NC-JT CSI corresponds to the strongest layer.

In the following embodiments, the CSI report(s) having the NC-JT CSI and the one or two sTRP CSIs may be reported in two parts (Part 1 and Part 2). Part 1 of the CSI has a fixed payload size, and the size of Part 2 can vary and depends on what is indicated in Part 1. Once the network receives and decodes Part 1 of the CSI reported by the UE, it knows the size of Part 2 and can proceed to receive and decode Part 2 of the CSI.

### Embodiments Related to CSI Reporting Details for NCJT CSI Omission for Option 1, X=1

In some embodiments, the WD is assumed to be configured with NCJT CSI reporting Option 1 with X=1, which means that the WD should report CSI for one sTRP measurement hypothesis (referred to as “sTRP CSI”) and, unless omitted, CSI for one NCJT measurement hypothesis (referred to as “NCJT CSI”). The omission of the NCJT CSI can, for example, depend on a rank threshold. For example, if the rank for the reported sTRP CSI is larger than 2, then the NCJT CSI may be omitted, since sTRP transmission may be assumed to outperform NCJT transmission when a UE can receive more than 2 layers from a sTRP (i.e., the channel from the UE to the sTRP is not rank deficient).

### Embodiment A1 (a Codepoint is Reserved in the CRI Field Used for Indicating CMR Pair for NCJT CSI Used to Indicate Omission of NCJT CSI)

In this embodiment it is assumed that Part 1 of the CSI report includes two CRI fields, where a first CRI field is used to indicate which CMR (channel measurement resource, which is a NZP CSI-RS resource) is used for the reported sTRP CSI and a second CRI field is used to indicate for which CMR pair the NCJT CSI is reported.

One solution for the first CRI field is to have an association between a codepoint and one of the CMRs in the NZP CSI-RS resource set configured for CSI reporting. In this case, the total number of bits for the first CRI field can be calculated as log 2 (Ks), where Ks is the total number of CMRs configured in the NZP CSI-RS resource set used for CSI reporting. Note that it might be specified in NR to support higher layer signaling (e.g., RRC and/or MAC CE signaling) used to indicate a subset of CMRs for which the WD should calculate sTRP measurement hypothesis. For example, suppose the subset consist of Km CMRs where Km is equal to or smaller than Ks. In this case, the bits in the first CRI field would be log 2 (Km).

In a similar fashion, for the second CRI field there can be an association between a codepoint and one of the N possible CMR pairs used for calculating NCJT measurement hypotheses. The maximum number of CMR pairs N used for NCJT measurement hypotheses may be equal to Nmax=2 (which means that N could be 1 or 2). The total number of bits for the second CRI field may be calculated as ceil (log 2 (N)). Note that if N is equal to one, no CRI field is needed since the CMR pair associated with the reported NCJT CSI is already known.

In some embodiments, an extra codepoint is reserved in the second CRI bitfield, and the extra codepoint is used to indicate omission of the NCJT CSI. For this case, the number of bits of the second CRI bitfield may be ceil (log 2 (1+N)) instead of ceil (log 2 (N)). One example of a codepoint mapping of the second CRI field for N=2 for such embodiments is shown below:
00=NCJT CSI reported for CMR pair 1.
01=NCJT CSI reported for CMR pair 2
11 (or 10)=no NCJT CSI reported

Note that this is just one example of a codepoint mapping. It is also possible that, for example, codepoint 00 indicates omission of NCJT CSI. Hence, when the second CRI bit field indicates a reserved codepoint, NCJT CSI is omitted from the CSI report. That is, only CRI, RI, PMI, CQI, and/or LI corresponding to the sTRP CSI is included in the CSI report (although the CRI field is present in part 1 of the CSI report, it points to a reserved codepoint and doesn't indicate a CMR pair for NCJT CSI).

Note that this embodiment is also applicable for CSI NCJT reporting Option 1 with X=2.

Embodiment A2 (Extra Codepoints in a Joint CRI Field Used for Indicating CMR for sTRP CSI and CMR Pair for NCJT CSI are Used to Indicate Omission of NCJT CSI)

In this embodiment, Part 1 is assumed to include a single joint CRI field (instead of two, as in Embodiment A1), which is used to indicate the CMR for the sTRP CSI, and the CMR pair for the NCJT CSI. The total number of bits for this CRI bitfield may be equal to ceil (log 2 (Ks*N)) or ceil (log 2 (Km*N)) in case a subset Km of the possible Ks sTRP CSI measurement hypotheses should be considered by the WD. One example of a mapping between codepoints and CMRs/CMR pair indications for Km=3 (CMR1, CMR2 & CMR3) and N=2 (CMR1&CMR2, and CMR1&CMR3) is as follows:
000=sTRP CSI reported for CMR1 & NCJT CSI reported for CMR1&CMR2;
001=sTRP CSI reported for CMR1 & NCJT CSI reported for CMR1&CMR3;
010=sTRP CSI reported for CMR2 & NCJT CSI reported for CMR1&CMR2;
011=sTRP CSI reported for CMR2 & NCJT CSI reported for CMR1&CMR3;
100=sTRP CSI reported for CMR3 & NCJT CSI reported for CMR1&CMR2; and/or.
101=sTRP CSI reported for CMR3 & NCJT CSI reported for CMR1&CMR3

In some embodiments, a set of extra codepoints in the single joint CRI field is used to indicate that NCJT CSI is omitted. In this case, the total number of bits in the bit field may be given by ceil (log 2 (Ks*(1+N))). One example of a mapping between codepoints and CMRs/CMR pair indications for Ks=3 (CMR1, CMR2 & CMR3) and N=2 (CMR1&CMR2 and CMR1&CMR3) is as follows:
0000=sTRP CSI reported for CMR1 & NCJT CSI reported for CMR1& CMR2;
0001=sTRP CSI reported for CMR1 & NCJT CSI reported for CMR1& CMR3;
0010=sTRP CSI reported for CMR1 & no NCJT CSI reported;
0011=sTRP CSI reported for CMR2 & NCJT CSI reported for CMR1& CMR2;
0100=sTRP CSI reported for CMR2 & NCJT CSI reported for CMR1& CMR3;
0101=sTRP CSI reported for CMR2 & no NCJT CSI reported. 0111=sTRP CSI reported for CMR3 & NCJT CSI reported for CMR1& CMR2;
1000=sTRP CSI reported for CMR3 & NCJT CSI reported for CMR1& CMR3; and/or.
1001=sTRP CSI reported for CMR3 & no NCJT CSI reported.

Hence, when the single joint CRI bit field indicates no NCJT CSI reporting, NCJT CSI is omitted from the CSI report. That is, only CRI, RI, PMI, CQI, and/or LI corresponding to the sTRP CSI is to be included in the CSI report (although the joint CRI field is present in part 1 of the CSI report, it points to only CMR(s) for the sTRP CSI and doesn't indicate a CMR pair for NCJT CSI). Although the above example is given with respect to a single sTRP CSI (i.e., X=1), it can be easily extended to cover the case with two sTRP CSIs (i.e., X=2) in which case the single CMR corresponding to sTRP CSI in the above example is replaced with two CMRs corresponding to two sTRP CSIs in the codepoint(s) of the joint CRI field.

Note that even though the examples show CMR resources associated with codepoints of the CRI field, these CMR resources may equivalently be replaced by CRIs (where a CRI uniquely identifies a CMR).

Embodiment A3 (a Codepoint is Reserved in the NCJT RI Field that Indicates Omission of NCJT CSI)

In this embodiment, separate RI fields in part 1 of the CSI report are used to indicate the rank for sTRP CSI and NCJT CSI.

Four different rank combinations are supported for NCJT CSI: {1, 1}, {1, 2}, {2,1}, {2,2}, which is here assumed to be indicated in one RI bitfield corresponding to NCJT CSI. Since there are four possible options, four codepoints may be used, which means that the bitfield should have 2 bits, where each codepoint of the bitfield is associated with one of the four candidate rank combinations. In some embodiments, an additional codepoint of this RI bitfield is used to indicate if the NCJT CSI report is omitted or not. One example of how the codepoints of the NCJT RI bitfield of this embodiment may be mapped is shown below:
000=Rank {1, 1};
001=Rank {1, 2};
010=Rank {2, 1};
011=Rank {2, 2}; and
111 (or 100, 101, 110)=no NCJT CSI reported

Hence, when the second RI bit field indicates a reserved codepoint as shown above, NCJT CSI is omitted from the CSI report. That is, only CRI, RI, PMI, CQI, and/or LI corresponding to the sTRP CSI is included in the CSI report (although the RI field for NCJT CSI is present in part 1 of the CSI report, it points to a reserved codepoint and does not indicate RI combinations for NCJT CSI).

In one alternative of this embodiment, a codepoint in the RI bitfield corresponding to the sTRP CSI(s) may be used to indicate omission of NCJT CSI instead of a codepoint in the NCJT RI bitfield.

Note that this embodiment is also applicable for CSI NCJT reporting Option1 with X=2.

Embodiment A4 (Extra Codepoints in the Joint sTRP Rank and NCJT Rank Indication Bitfield is Reserved for Indicating Omission of NCJT CSI)

In this embodiment, a single RI bitfield may be used to indicate the ranks for both sTRP CSI and NCJT CSI. Assume that the maximum sTRP rank for the WD is 4 (for example, if the WD has 4 RX chains). In this case, there will exist 4 candidate sTRP rank indications (1, 2, 3 or 4) and 4 candidate NCJT rank indications (as described above). The total number of possible rank combinations for both the sTRP CSI and the NCJT CSI may then be (#candidate_sTRP_ranks*#candidate_NCJT_ranks)=(4*4)=16. This means that 16 codepoints may be needed which may call for a bitfield of ceil (log 2 (16))=4 bits. One example of the codepoint mapping is:
0000=sTRP Rank 1 and NCJT Rank {1, 1};
0001=sTRP Rank 2 and NCJT Rank {1, 1};
0010=sTRP Rank 3 and NCJT Rank {1, 1};
0011=sTRP Rank 4 and NCJT Rank {1, 1};
0100=sTRP Rank 1 and NCJT Rank {1, 2};
0101=sTRP Rank 2 and NCJT Rank {1, 2};
0110=sTRP Rank 3 and NCJT Rank {1, 2};
0111=sTRP Rank 4 and NCJT Rank {1, 2};
1000=sTRP Rank 1 and NCJT Rank {2, 1};
1001=sTRP Rank 2 and NCJT Rank {2, 1};
1010=sTRP Rank 3 and NCJT Rank {2, 1};
1011=sTRP Rank 4 and NCJT Rank {2, 1};
1100=sTRP Rank 1 and NCJT Rank {2, 2};
1101=sTRP Rank 2 and NCJT Rank {2, 2};
1110=sTRP Rank 3 and NCJT Rank {2, 2}; and
1111=sTRP Rank 4 and NCJT Rank {2, 2}.

In some embodiments, a set of extra codepoints in the joint sTRP and NCJT rank indication bitfield may be used to indicate that NCJT CSI is omitted. In this case the total number of bits required in the bit field could be, for example:

$$Numbers bits = ceil ( log 2 ( ( \# candidate\_sTRP \_ranks * ( \# candidate\_NCJT \_ranks + 1 ) ) .$$

One example of the codepoint mapping is:
00000=sTRP Rank 1 and NCJT Rank {1, 1};
00001=sTRP Rank 2 and NCJT Rank {1, 1};
00010=sTRP Rank 3 and NCJT Rank {1, 1};
00011=sTRP Rank 4 and NCJT Rank {1, 1};
00100=sTRP Rank 1 and NCJT Rank {1, 2};
00101=sTRP Rank 2 and NCJT Rank {1, 2};
00110=sTRP Rank 3 and NCJT Rank {1, 2};
00111=sTRP Rank 4 and NCJT Rank {1, 2};
01000=sTRP Rank 1 and NCJT Rank {2, 1};
01001=sTRP Rank 2 and NCJT Rank {2, 1};
01010=sTRP Rank 3 and NCJT Rank {2, 1};
01011=sTRP Rank 4 and NCJT Rank {2, 1};
01100=sTRP Rank 1 and NCJT Rank {2, 2};
01101=sTRP Rank 2 and NCJT Rank {2, 2};
01110=sTRP Rank 3 and NCJT Rank {2, 2};
01111=sTRP Rank 4 and NCJT Rank {2, 2};
10000=sTRP Rank 1 and no NCJT CSI;
10001=sTRP Rank 2 and no NCJT CSI;
10010=sTRP Rank 3 and no NCJT CSI; and
10011=sTRP Rank 4 and no NCJT CSI.

In one alternative of this embodiment, there is an NCJT omission rule that is based at least in part on the sTRP rank. For example, the rule can be that NCJT CSI is omitted in case the sTRP rank is larger than 2. In this case, the number of codepoints (and also the number of bits) in the sTRP and NCJT rank indication bitfield could be reduced. One example of the codepoint mapping is:
0000=sTRP Rank 1 and NCJT Rank {1, 1};
0001=sTRP Rank 2 and NCJT Rank {1, 1};
0010=sTRP Rank 1 and NCJT Rank {1, 2};
0011=sTRP Rank 2 and NCJT Rank {1, 2};
0100=sTRP Rank 1 and NCJT Rank {2, 1};
0101=sTRP Rank 2 and NCJT Rank {2, 1};
0110=sTRP Rank 1 and NCJT Rank {2, 2};
0111=sTRP Rank 2 and NCJT Rank {2, 2}
1000=sTRP Rank 3 and no NCJT CSI; and
1001=sTRP Rank 4 and no NCJT CSI.

It can be seen that this alternative of this embodiment reduces the number of codepoints (10 instead of 20) and hence, the number of bits (4 instead of 5) to be used in the CSI report compared to alternate embodiments described above.

In one alternative of this embodiment, instead of omitting NCJT CSI based at least in part on an absolute sTRP rank value, relative rank indications can be used. For example, the NCJT CSI may be omitted in case the rank of the sTRP CSI is larger than the rank for the NCJT CSI. One example of the codepoint mapping for this case is:
0000=sTRP Rank 1 and NCJT Rank {1, 1};
0001=sTRP Rank 2 and NCJT Rank {1, 1};
0010=sTRP Rank 1 and NCJT Rank {1, 2};
0011=sTRP Rank 2 and NCJT Rank {1, 2};
0100=sTRP Rank 3 and NCJT Rank {1, 2};
0101=sTRP Rank 1 and NCJT Rank {2, 1};
0110=sTRP Rank 2 and NCJT Rank {2, 1};
0111=sTRP Rank 3 and NCJT Rank {2, 1};
1000=sTRP Rank 1 and NCJT Rank {2, 2};
1001=sTRP Rank 2 and NCJT Rank {2, 2};
1010=sTRP Rank 3 and NCJT Rank {2, 2};
1011=sTRP Rank 4 and NCJT Rank {2, 2};
1100=sTRP Rank 2 and no NCJT CSI (this codepoint might be removed since unlikely);
1101=sTRP Rank 3 and no NCJT CSI; and
1110=sTRP Rank 4 and no NCJT CSI.

Hence, when the joint RI bit field indicates no NCJT CSI reporting, NCJT CSI may be omitted from the CSI report. That is, only CRI, RI, PMI, CQI, and/or LI corresponding to the sTRP CSI may be included in the CSI report (although the joint RI field is present in part 1 of the CSI report, it points to only RI(s) for the sTRP CSI and does not indicate a RI combination for NCJT CSI).

Although the examples consider a maximum rank of 4 for sTRP CSIs, the embodiments can be easily extended to cover cases where the rank of the sTRP CSIs can be larger than 4 (e.g., 8).

### Embodiments Related to CSI Reporting Details for NCJT CSI Omission for Option 1, X=2

In these set of embodiments, the WD is configured with NCJT CSI reporting Option 1 with X=2, which means that the WD should report CSI for two sTRP CSI measurement hypotheses and, unless omitted, CSI for one NCJT measurement hypothesis.

Embodiment B1 (Extra Codepoints in the CRI Field Used for Indicating Two CMRs for Two sTRP CSIs and a CMR Pair for NCJT CSI are Used to Indicate Omission of NCJT CSI)

In this embodiment, Part 1 of the CSI report is assumed to include a single CRI field, which is used to indicate the CMRs for two sTRP CSI, and the CMR pair for the NCJT CSI. Assume that the number of CMRs configured in CMR group 0 is such that the number of CMRs the WD should calculate sTRP CSI for is equal to KM0 and the number of CMRs configured in CMR group 1 is that the number of CMRs the WD should calculate sTRP CSI for is equal to KM1. Further assume that the number of CMR pairs the WD should calculate NCJT CSI for is N, then the total number of bits in the bitfield may be given by ceil (log 2 (KM0*KM1*N)). One example of a mapping between codepoints and CMRs/CMR pair indications for KM0=2 (CMR1, CMR2), KM1=1 (CMR3) and N=2 (CMR1&CMR2, and CMR1&CMR3) may be as follow:
00=STRP CSI for CMR1, sTRP CSI for CMR3 & NCJT CSI for CMR1&CMR2;
01=sTRP CSI for CMR2, sTRP CSI for CMR3 & NCJT CSI for CMR1&CMR2;
10=sTRP CSI for CMR1, sTRP CSI for CMR3 & NCJT CSI for CMR1&CMR3; and
11=sTRP CSI for CMR2, sTRP CSI for CMR3 & NCJT CSI for CMR1&CMR3.

In some embodiments, a set of extra codepoints are used to indicate that NCJT CSI is omitted. In this case the total number of bits required in the bit field may be given by ceil (log 2 (KM0*KM1*(N+1))). One example of a mapping between codepoints and CMRs/CMR pair indications for KM0=2 (CMR1, CMR2), KM1=1 (CMR3) and N=2 (CMR1&CMR2, and CMR1&CMR3) may be as follow:
000=STRP CSI for CMR1, sTRP CSI for CMR3 & NCJT CSI for CMR1&CMR2;
001=sTRP CSI for CMR2, sTRP CSI for CMR3 & NCJT CSI for CMR1&CMR2;
010=sTRP CSI for CMR1, sTRP CSI for CMR3 & NCJT CSI for CMR1&CMR3;
011=sTRP CSI for CMR2, sTRP CSI for CMR3 & NCJT CSI for CMR1&CMR3;
100=sTRP CSI for CMR1, sTRP CSI for CMR3 & no NCJT CSI; and 101=sTRP CSI for CMR2, sTRP CSI for CMR3 & no NCJT CSI.

Hence, when the single joint CRI bit field indicates no NCJT CSI reporting, NCJT CSI may be omitted from the CSI report. That is, only CRIs, RIs, PMIs, CQIs, and/or LI corresponding to the two sTRP CSI may be included in the CSI report (although the joint CRI field is present in part 1 of the CSI report, it points to only CMR(s) for the sTRP CSI and does not indicate a CMR pair for NCJT CSI).

Embodiment B2 (Extra Codepoints in the Joint sTRP Rank and NCJT Rank Indication Bitfield is Reserved for Indicating Omission of NCJT CSI)

In this embodiment, assume that a single joint RI bitfield is used to indicate the ranks for both sTRP CSI and one NCJT CSI. Also, assume that the maximum sTRP rank for the WD is 4 (for example if the WD has 4 RX chains). In this case, there will exist 4 candidate sTRP rank indications (1, 2, 3 or 4) per sTRP CSI and 4 candidate NCJT rank indications. The total number of possible rank combinations for both the sTRP CSIs and the NCJT CSI is then:

$$( \# candidate\_sTRP \_ranks \hat{} 2 * \# candidate\_NCJT \_ranks ) = ( 4 \hat{} 2 * 4 ) = 64.$$

This mean that 64 codepoints are needed which requires a bitfield of ceil (log 2 (64))=6 bits. One example of the codepoint is:
000001=sTRP1 Rank 2, sTRP2 Rank 1 and NCJT Rank {1, 1};
000010=sTRP1 Rank 3, sTRP2 Rank 1 and NCJT Rank {1, 1};
000011=sTRP1 Rank 4, sTRP2 Rank 1 and NCJT Rank {1, 1};
000100=sTRP1 Rank 1, sTRP2 Rank 2 and NCJT Rank {1, 1};
000101=sTRP1 Rank 2, sTRP2 Rank 2 and NCJT Rank {1, 1};
000110=sTRP1 Rank 3, sTRP2 Rank 2 and NCJT Rank {1, 1};
000111=sTRP1 Rank 4, sTRP2 Rank 2 and NCJT Rank {1, 1};
001000=sTRP1 Rank 1, sTRP2 Rank 3 and NCJT Rank {1, 1};
001001=sTRP1 Rank 2, sTRP2 Rank 3 and NCJT Rank {1, 1};
001010=sTRP1 Rank 3, sTRP2 Rank 3 and NCJT Rank {1, 1};
001011=sTRP1 Rank 4, sTRP2 Rank 3 and NCJT Rank {1, 1};
001100=sTRP1 Rank 1, sTRP2 Rank 4 and NCJT Rank {1, 1};
001101=sTRP1 Rank 2, sTRP2 Rank 4 and NCJT Rank {1, 1};
001110=sTRP1 Rank 3, sTRP2 Rank 4 and NCJT Rank {1, 1};
001111=sTRP1 Rank 4, sTRP2 Rank 4 and NCJT Rank {1, 1};
010000=sTRP1 Rank 1, sTRP2 Rank 1 and NCJT Rank {1, 2};
010001=sTRP1 Rank 2, sTRP2 Rank 1 and NCJT Rank {1, 2};
010010=sTRP1 Rank 3, sTRP2 Rank 1 and NCJT Rank {1, 2};
010011=sTRP1 Rank 4, sTRP2 Rank 1 and NCJT Rank {1, 2};
010100=sTRP1 Rank 1, sTRP2 Rank 2 and NCJT Rank {1, 2};
010101=sTRP1 Rank 2, sTRP2 Rank 2 and NCJT Rank {1, 2};
010110=sTRP1 Rank 3, sTRP2 Rank 2 and NCJT Rank {1, 2};
010111=sTRP1 Rank 4, sTRP2 Rank 2 and NCJT Rank {1, 2};
011000=sTRP1 Rank 1, sTRP2 Rank 3 and NCJT Rank {1, 2};
011001=sTRP1 Rank 2, sTRP2 Rank 3 and NCJT Rank {1, 2};
011010=sTRP1 Rank 3, sTRP2 Rank 3 and NCJT Rank {1, 2};
011011=sTRP1 Rank 4, sTRP2 Rank 3 and NCJT Rank {1, 2};
011100=sTRP1 Rank 1, sTRP2 Rank 4 and NCJT Rank {1, 2};
011101=sTRP1 Rank 2, sTRP2 Rank 4 and NCJT Rank {1, 2};
011110=sTRP1 Rank 3, sTRP2 Rank 4 and NCJT Rank {1, 2};
011111=sTRP1 Rank 4, sTRP2 Rank 4 and NCJT Rank {1, 2};
. . .
. . .
111111=sTRP1 Rank 4, sTRP2 Rank 4 and NCJT Rank {2, 2}.

In some embodiments, a set of extra codepoints in the joint sTRP and NCJT rank indication bitfield may be used to indicate that NCJT CSI is omitted. In this case the total number of bits required in the bit field may be, for example:

$$Number bits = ceil ( log 2 ( ( \#candidate \_sTRP \_ranks \hat{} 2 * ( \#candidate \_CNJT \_ranks + 1 ) ) .$$

One example of the codepoint mapping is:
0000000=sTRP1 Rank 1, sTRP2 Rank 1 and NCJT Rank {1, 1};
0000001=sTRP1 Rank 2, sTRP2 Rank 1 and NCJT Rank {1, 1};
0000010=sTRP1 Rank 3, sTRP2 Rank 1 and NCJT Rank {1, 1};
0000011=sTRP1 Rank 4, sTRP2 Rank 1 and NCJT Rank {1, 1};
0000100=sTRP1 Rank 1, sTRP2 Rank 2 and NCJT Rank {1, 1};
0000101=sTRP1 Rank 2, sTRP2 Rank 2 and NCJT Rank {1, 1};
0000110=sTRP1 Rank 3, sTRP2 Rank 2 and NCJT Rank {1, 1};
0000111=sTRP1 Rank 4, sTRP2 Rank 2 and NCJT Rank {1, 1};
0001000=sTRP1 Rank 1, sTRP2 Rank 3 and NCJT Rank {1, 1};
0001001=sTRP1 Rank 2, sTRP2 Rank 3 and NCJT Rank {1, 1};
0001010=sTRP1 Rank 3, sTRP2 Rank 3 and NCJT Rank {1, 1};
0001011=sTRP1 Rank 4, sTRP2 Rank 3 and NCJT Rank {1, 1};
0001100=sTRP1 Rank 1, sTRP2 Rank 4 and NCJT Rank {1, 1};
0001101=sTRP1 Rank 2, sTRP2 Rank 4 and NCJT Rank {1, 1};
0001110=sTRP1 Rank 3, sTRP2 Rank 4 and NCJT Rank {1, 1};
0001111=sTRP1 Rank 4, sTRP2 Rank 4 and NCJT Rank {1, 1};
0010000=sTRP1 Rank 1, sTRP2 Rank 1 and NCJT Rank {1, 2};
0010001=sTRP1 Rank 2, sTRP2 Rank 1 and NCJT Rank {1, 2};
0010010=sTRP1 Rank 3, sTRP2 Rank 1 and NCJT Rank {1, 2};
0010011=sTRP1 Rank 4, sTRP2 Rank 1 and NCJT Rank {1, 2};
0010100=sTRP1 Rank 1, sTRP2 Rank 2 and NCJT Rank {1, 2};
0010101=sTRP1 Rank 2, sTRP2 Rank 2 and NCJT Rank {1, 2};
0010110=sTRP1 Rank 3, sTRP2 Rank 2 and NCJT Rank {1, 2};
0010111=sTRP1 Rank 4, sTRP2 Rank 2 and NCJT Rank {1, 2};
0011000=sTRP1 Rank 1, sTRP2 Rank 3 and NCJT Rank {1, 2};
0011001=sTRP1 Rank 2, sTRP2 Rank 3 and NCJT Rank {1, 2};
0011010=sTRP1 Rank 3, sTRP2 Rank 3 and NCJT Rank {1, 2};
0011011=sTRP1 Rank 4, sTRP2 Rank 3 and NCJT Rank {1, 2};
0011100=sTRP1 Rank 1, sTRP2 Rank 4 and NCJT Rank {1, 2};
0011101=sTRP1 Rank 2, sTRP2 Rank 4 and NCJT Rank {1, 2};
0011110=sTRP1 Rank 3, sTRP2 Rank 4 and NCJT Rank {1, 2}
0011111=sTRP1 Rank 4, sTRP2 Rank 4 and NCJT Rank {1, 2};
. . .
. . .
0111111=sTRP1 Rank 4, sTRP2 Rank 4 and no NCJT;
1000000=STRP1 Rank 1, sTRP2 Rank 1 and no NCJT;
1000001=sTRP1 Rank 2, sTRP2 Rank 1 and no NCJT;
1000010=sTRP1 Rank 3, sTRP2 Rank 1 and no NCJT;
. . .
. . .
1000011=sTRP1 Rank 4, sTRP2 Rank 1 and no NCJT;
1000100=sTRP1 Rank 1, sTRP2 Rank 2 and no NCJT;
1000101=sTRP1 Rank 2, sTRP2 Rank 2 and no NCJT;
1000110=sTRP1 Rank 3, sTRP2 Rank 2 and no NCJT;
1000111=sTRP1 Rank 4, sTRP2 Rank 2 and no NCJT;
1001000=sTRP1 Rank 1, sTRP2 Rank 3 and no NCJT;
1001001=sTRP1 Rank 2, sTRP2 Rank 3 and no NCJT;
1001010=sTRP1 Rank 3, sTRP2 Rank 3 and no NCJT;
1001011=sTRP1 Rank 4, sTRP2 Rank 3 and no NCJT;
1001100=sTRP1 Rank 1, sTRP2 Rank 4 and no NCJT;
1001101=sTRP1 Rank 2, sTRP2 Rank 4 and no NCJT;
1001110=sTRP1 Rank 3, sTRP2 Rank 4 and no NCJT; and
1001111=sTRP1 Rank 4, sTRP2 Rank 4 and no NCJT.

In one alternative of this embodiment, there may be a NCJT omission rule that is based at least in part on the sTRP rank. For example, the rule may be that NCJT CSI is omitted in case the sTRP rank is larger than 2. In this case, the number of codepoints (and also the number of bits) in the sTRP and NCJT rank indication bitfield may be reduced. For example, codepoints associated with a sTRP rank higher than 3 and a NCJT CSI rank indication can be removed. Alternatively stated, the codepoints that have a sTRP CSI rank higher than 3 indicate no NCJT CSI (or it does not provide any RI combinations for NCJT CSI).

Hence, when the joint RI bit field indicates no NCJT CSI reporting, NCJT CSI may be omitted from the CSI report. That is, only CRI, RI, PMI, CQI, and/or LI corresponding to the two sTRP CSI(s) are included in the CSI report (although the joint RI field is present in part 1 of the CSI report, it points to only RI(s) for the two sTRP CSIs and does not indicate a RI combination for NCJT CSI).

Although the examples consider a maximum rank of 4 for sTRP CSIs, the embodiments can easily be extended to cover cases where the rank of the sTRP CSIs can be larger than 4 (e.g., 8).

In one alternative of this embodiment, instead of omitting NCJT CSI based at least in part on an absolute sTRP rank value, relative rank indications can be used, for example such that NCJT CSI is omitted in case the rank of the sTRP CSI is larger than the rank for the NCJT CSI.

### Extension to the Concepts of the Disclosure

In some embodiments, an explicit new single bit bitfield is included in Part 1 of the NCJT CSI report, and the new field is used to indicate if NCJT CSI is omitted. For example, if the new bitfield indicates a first value (e.g., “1”), then NCJT CSI report may be included, and if the field indicates a second value is (e.g., “0”), then the NCJT CSI may be omitted.

In another embodiment, NCJT CSI in part 2 of a CSI report may be omitted if the corresponding NCJT wideband CQI=0 is reported in part 1 of the report. CQI=0 may be used to indicate that CQI is “out of range” and cannot be used to schedule anything for NCJT. This can be used also to indicate that the corresponding CSI in part 2 is not present.

To save feedback overhead in part 1, subband CQI may be included in part 2 of a CSI report so that if a NC-JT CSI is to be omitted, the corresponding subband CQI is not reported.

When X>0 and the CSI report payload exceeds a threshold, for example, as defined in 3GPP TS 38.214 v16.5.0 section 5.2.3, sTRP CSI(s) have a higher priority than NC-JT CSI. If X=2, the sTRP CSI associated with an sTRP hypothesis with the lower index has a higher priority than the sTRP CSI associated with an sTRP hypothesis with the higher index. In some embodiments, the priority index (e.g., lower index or higher index) may be configured to the UE via higher layers (e.g., via RRC configuration and/or MAC CE signaling).

According to one aspect, a network node configured to communicate with a wireless device, WD, is provided. The network node includes a radio interface and processing circuitry configured to configure the WD to transmit a channel state information, CSI, report for at least one transmission reception point, TRP, measurement hypothesis; and configure the WD to conditionally omit a non-coherent joint transmission, NCJT, CSI report.

According to this aspect, in some embodiments, the conditionally omitting is based at least in part on a rank indicator. In some embodiments, the conditionally omitting is based at least in part on a codepoint mapping of a CSI reference signal, RS, resource indicator, CRI field. In some embodiments, the conditionally omitting is based at least in part on a TRP rank. In some embodiments, the network node, radio interface, and/or processing circuitry are further configured to configure the WD with a set of channel measurement resources, CMR, for which to calculate the TRP measurement hypothesis.

According to another aspect, a method implemented in a network node includes: configuring the WD to transmit a channel state information, CSI, report for at least one transmission reception point, TRP, measurement hypothesis; and configuring the WD to conditionally omit a non-coherent joint transmission, NCJT, CSI report.

According to this aspect, in some embodiments, the conditionally omitting is based at least in part on a rank indicator. In some embodiments, the conditionally omitting is based at least in part on a codepoint mapping of a CSI reference signal, RS, resource indicator, CRI field. In some embodiments, the conditionally omitting is based at least in part on a TRP rank. In some embodiments, the method also includes configuring the WD with a set of channel measurement resources, CMR, for which to calculate the TRP measurement hypothesis.

According to yet another aspect, a wireless device (WD) configured to communicate with a network node is provided. The WD includes a radio interface and/or processing circuitry configured to: determine when to omit a non-coherent joint transmission, NCJT, channel state information report based on one of a rank indication and a codepoint; and transmit a CSI report that includes or omits the NCJT CSI report based on the determination.

According to this aspect, in some embodiments, the NCJT CSI report is configured to include a first part and a second part, the first part being fixed in size and the second part having a size based at least in part on the first part. In some embodiments, the first part includes two channel state information resource indicator, CRI, fields, a first of the CRI fields indicating an association between a channel management resource, CMR, and a transmission reception point, TRP, and a second of the CRI fields indicating an association between NCJT CSI and a CMR pair. In some embodiments, the second CRI field carries a codepoint indicating an omission or inclusion of the NCJT CSI report. In some embodiments, the first part includes a single channel state information resource indicator, CRI, field indicating a channel management resource, CMR, for a transmission reception point CSI, and further indicating a CMR pair for the NCJT CSI. In some embodiments, a rank of a transmission reception point. TRP. CSI and the NCJT CSI are indicated by at least one rank indicator field. In some embodiments, a codepoint in the TRP CSI rank indicator indicates omission of the NCJT CSI report. In some embodiments, a rank of a transmission reception point, TRP, CSI greater than two indicates omission of the NCJT CSI report. In some embodiments, omission of the NCJT CSI report is indicated by a rank of the TRP CSI is larger than a rank of the NCJT CSI. In some embodiments, the first part includes a single bit field to indicate channel measurement resources, CMR, for two transmission reception point. TRP, CSIs and a CMR pair for the NCJT-CS. In some embodiments, omission of the NCJT CSI report is indicated by a corresponding channel quality indicator, CQI.

According to another aspect, a method implemented in a wireless device (WD), includes: determining when to omit a non-coherent joint transmission, NCJT, channel state information report based on one of a rank indication and a codepoint; and transmitting a CSI report that includes or omits the NCJT CSI report based on the determination.

According to this aspect, in some embodiments, the NCJT CSI report is configured to include a first part and a second part, the first part being fixed in size and the second part having a size based at least in part on the first part. In some embodiments, the first part includes two channel state information resource indicator, CRI, fields, a first of the CRI fields indicating an association between a channel management resource, CMR, and a transmission reception point, TRP, and a second of the CRI fields indicating an association between NCJT CSI and a CMR pair. In some embodiments, the second CRI field carries a codepoint indicating an omission or inclusion of the NCJT CSI report. In some embodiments, the first part includes a single channel state information resource indicator, CRI, field indicating a channel management resource, CMR, for a transmission reception point CSI, and further indicating a CMR pair for the NCJT CSI. In some embodiments, a rank of a transmission reception point. TRP. CSI and the NCJT CSI are indicated by at least one rank indicator field. In some embodiments, a codepoint in the TRP CSI rank indicator indicates omission of the NCJT CSI report. In some embodiments, a rank of a transmission reception point. TRP, CSI greater than two indicates omission of the NCJT CSI report. In some embodiments, omission of the NCJT CSI report is indicated by a rank of the TRP CSI is larger than a rank of the NCJT CSI. In some embodiments, the first part includes a single bit field to indicate channel measurement resources, CMR, for two transmission reception point, TRP, CSIs and a CMR pair for the NCJT-CS. In some embodiments, omission of the NCJT CSI report is indicated by a corresponding channel quality indicator, CQI.

Some embodiments may include one or more of the following:

Embodiment A1. A network node configured to communicate with a wireless device, WD, the network node configured to, and/or comprising a radio interface and/or comprising processing circuitry configured to:
configure the WD to transmit a channel state information, CSI, report for at least one transmission reception point, TRP, measurement hypothesis; and
configure the WD to conditionally omit a non-coherent joint transmission, NCJT, CSI report.

Embodiment A2. The network node of Embodiment A1, wherein the conditionally omitting is based at least in part on a rank indicator.

Embodiment A3. The network node of Embodiment A1, wherein the conditionally omitting is based at least in part on a codepoint mapping of a CSI reference signal, RS, resource indicator, CRI field.

Embodiment A4. The network node of Embodiment A1, wherein the conditionally omitting is based at least in part on a TRP rank.

Embodiment A5. The network node of Embodiment A1, wherein network node, radio interface, and/or processing circuitry are further configured to configure the WD with a set of channel measurement resources, CMR, for which to calculate the TRP measurement hypothesis.

Embodiment B1. A method implemented in a network node, the method comprising:
configuring the WD to transmit a channel state information, CSI, report for at least one transmission reception point, TRP, measurement hypothesis; and
configuring the WD to conditionally omit a non-coherent joint transmission, NCJT, CSI report.

Embodiment B2. The method of Embodiment B1, wherein the conditionally omitting is based at least in part on a rank indicator.

Embodiment B3. The method of Embodiment B1, wherein the conditionally omitting is based at least in part on a codepoint mapping of a CSI reference signal, RS, resource indicator, CRI field.

Embodiment B4. The method of Embodiment B1, wherein the conditionally omitting is based at least in part on a TRP rank.

Embodiment B5. The method of Embodiment B1, further comprising configuring the WD with a set of channel measurement resources, CMR, for which to calculate the TRP measurement hypothesis.

Embodiment C1. A wireless device (WD) configured to communicate with a network node, the WD configured to, and/or comprising a radio interface and/or processing circuitry configured to:
determine when to omit a non-coherent joint transmission, NCJT, channel state information report based on one of a rank indication and a codepoint; and
transmit a CSI report that includes or omits the NCJT CSI report based on the determination.

Embodiment C2. The WD of Embodiment C1, wherein the NCJT CSI report is configured to include a first part and a second part, the first part being fixed in size and the second part having a size based at least in part on the first part.

Embodiment C3. The WD of Embodiment C2, wherein the first part includes two channel state information resource indicator, CRI, fields, a first of the CRI fields indicating an association between a channel management resource, CMR, and a transmission reception point, TRP, and a second of the CRI fields indicating an association between NCJT CSI and a CMR pair.

Embodiment C4. The WD of Embodiment C3, wherein the second CRI field carries a codepoint indicating an omission or inclusion of the NCJT CSI report.

Embodiment C5. The WD of Embodiment C2, wherein the first part includes a single channel state information resource indicator, CRI, field indicating a channel management resource, CMR, for a transmission reception point CSI, and further indicating a CMR pair for the NCJT CSI.

Embodiment C6. The WD of Embodiment C1, wherein a rank of a transmission reception point, TRP, CSI and the NCJT CSI are indicated by at least one rank indicator field.

Embodiment C7. The WD of Embodiment C6, wherein a codepoint in the TRP CSI rank indicator indicates omission of the NCJT CSI report.

Embodiment C8. The WD of Embodiment C6, wherein a rank of a transmission reception point, TRP, CSI greater than two indicates omission of the NCJT CSI report.

Embodiment C9. The WD of Embodiment C6, wherein omission of the NCJT CSI report is indicated by a rank of the TRP CSI is larger than a rank of the NCJT CSI.

Embodiment C10. The WD of Embodiment C2, wherein the first part includes a single bit field to indicate channel measurement resources, CMR, for two transmission reception point, TRP, CSIs and a CMR pair for the NCJT-CS.

Embodiment C11. The WD of Embodiment C1, wherein omission of the NCJT CSI report is indicated by a corresponding channel quality indicator, CQI.

Embodiment D1. A method implemented in a wireless device (WD), the method comprising:
determining when to omit a non-coherent joint transmission, NCJT, channel state information report based on one of a rank indication and a codepoint; and
transmitting a CSI report that includes or omits the NCJT CSI report based on the determination.

Embodiment D2. The method of Embodiment D1, wherein the NCJT CSI report is configured to include a first part and a second part, the first part being fixed in size and the second part having a size based at least in part on the first part.

Embodiment D3. The method of Embodiment D2, wherein the first part includes two channel state information resource indicator, CRI, fields, a first of the CRI fields indicating an association between a channel management resource, CMR, and a transmission reception point, TRP, and a second of the CRI fields indicating an association between NCJT CSI and a CMR pair.

Embodiment D4. The method of Embodiment D3, wherein the second CRI field carries a codepoint indicating an omission or inclusion of the NCJT CSI report.

Embodiment D5. The method of Embodiment D2, wherein the first part includes a single channel state information resource indicator, CRI, field indicating a channel management resource, CMR, for a transmission reception point CSI, and further indicating a CMR pair for the NCJT CSI.

Embodiment D6. The method of Embodiment D1, wherein a rank of a transmission reception point, TRP, CSI and the NCJT CSI are indicated by at least one rank indicator field.

Embodiment D7. The method of Embodiment D6, wherein a codepoint in the TRP CSI rank indicator indicates omission of the NCJT CSI report.

Embodiment D8. The method of Embodiment D6, wherein a rank of a transmission reception point, TRP, CSI greater than two indicates omission of the NCJT CSI report.

Embodiment D9. The method of Embodiment D6, wherein omission of the NCJT CSI report is indicated by a rank of the TRP CSI is larger than a rank of the NCJT CSI.

Embodiment D10. The method of Embodiment D2, wherein the first part includes a single bit field to indicate channel measurement resources, CMR, for two transmission reception point, TRP, CSIs and a CMR pair for the NCJT-CS.

Embodiment D11. The method of Embodiment D1, wherein omission of the NCJT CSI report is indicated by a corresponding channel quality indicator, CQI.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
configuring the WD for at least one of single transmission-and-reception point, TRP, channel state information, CSI, reporting and joint TRP CSI reporting, the CSI reporting being based at least in part on channel measurements measured on channel measurement resources, CMR, associated with each of at least one TRP; and
receiving from the WD an indication of one of single-TRP CSI reporting and joint-TRP CSI reporting.

2. The method of claim 1, wherein the indication is included in a channel resource indicator, CRI, field configured to indicate for which of at least one TRP, CSI is reported.

3. The method of claim 2, wherein the CRI field is configured to indicate omission of joint CSI reporting for at least one of a plurality of TRPs.

4. The method of claim 1, wherein the indication is included in a rank indicator field including bits reserved for single and joint CSI reporting rank indications, and wherein configuring the WD includes indicating a first rank for single CSI reporting and a second rank for joint CSI reporting.

5. (canceled)

6. A network node configured to communicate with a wireless device, WD, the network node comprising:
processing circuitry configured to configure the WD for at least one of single transmission-and-reception point, TRP, channel state information, CSI, reporting and joint TRP CSI reporting, the CSI reporting being based at least in part on channel measurements measured on channel measurement resources, CMR, associated with each of at least one TRP; and
a radio interface in communication with the processing circuitry and configured to receive from the WD an indication of one of single-TRP CSI reporting and joint-TRP CSI reporting.

7. The network node of claim 6, wherein the indication is included in a channel resource indicator, CRI, field configured to indicate for which of at least one TRP, CSI is reported.

8. The network node of claim 7, wherein the CRI field is configured to indicate omission of joint CSI reporting for at least one of a plurality of TRPs.

9. The network node of claim 8, wherein the indication is included in a rank indicator field including bits reserved for single and joint CSI reporting rank indications, and wherein configuring the WD includes indicating a first rank for single CSI reporting and a second rank for joint CSI reporting.

10. (canceled)

11. A method in a wireless device, WD, configured to communicate with a network node, the method comprising:
performing channel measurements on each of a plurality of channel measurement resources, CMR, associated with each of at least one transmission-and-reception point, TRP; and
transmitting to the network node an indication of at least one of reporting single-TRP channel state information, CSI, and reporting joint-TRP CSI, the CSI reporting being based at least in part on channel measurements on the CMR associated with at least one TRP for which CSI is reported.

12. The method of claim 11, wherein the indication is included in a channel resource indicator, CRI, field configured to indicate for which of at least one TRP, CSI is reported.

13. The method of claim 12, wherein the CRI field is configured to indicate omission of joint-TRP CSI reporting for at least one of a plurality of TRPs.

14. The method of claim 11, wherein a CSI report includes a first part and a second part, the first part of the CSI report indicating for which CMR the CSI is reported, the second part of the CSI report reporting CSI for the indicated CMR.

15. The method of claim 14, wherein the first part of the CSI report includes a first field to indicate for which CMR the single-TRP CSI is reported and a second field to indicate for which CMR joint-TRP CSI is reported.

16. The method of claim 15, wherein the second field includes one or both of:
at least one codepoint reserved to indicate inclusion of CSI reporting of at least one of a set of joint-TRP CSI; and
at least one codepoint reserved to indicate omission of CSI reporting of at least one of a set of joint-TRP CSI.

17. (canceled)

18. The method of claim 11, wherein the indication is included in a rank indicator field including bits reserved for reporting rank indications for single-TRP CSI reporting and joint-TRP CSI reporting.

19. The method of claim 18, wherein a first rank is indicated for single-TRP CSI reporting and a second rank is indicated for joint-TRP CSI reporting.

20. The method of claim 11, wherein joint-TRP CSI reporting is omitted when a rank indication exceeds a rank threshold.

21. A wireless device, WD, configured to communicate with a network node, the wireless device comprising a radio interface configured to:
perform channel measurements on each of a plurality of channel measurement resources, CMR, associated with each of at least one transmission-and-reception point, TRP; and
transmit to the network node an indication of at least one of reporting single-TRP channel state information, CSI, and reporting joint-TRP CSI, the CSI reporting being based at least in part on channel measurements on the CMR associated with at least one TRP for which CSI is reported.

22. The WD of claim 21, wherein the indication is included in a channel resource indicator, CRI, field configured to indicate for which of at least one TRP, CSI is reported.

23. The WD of claim 22, wherein the CRI field is configured to indicate omission of joint-TRP CSI reporting for at least one of a plurality of TRPs.

24. The WD of claim 21, wherein a CSI report includes a first part and a second part, the first part of the CSI report indicating for which CMR the CSI is reported, the second part of the CSI report reporting CSI for the indicated CMR.

25. The WD of claim 24, wherein the first part of the CSI report includes a first field to indicate for which CMR the single-TRP CSI is reported and a second field to indicate for which CMR joint-TRP CSI is reported.

26. The WD of claim 25, wherein the second field includes one or both of:
at least one codepoint reserved to indicate inclusion of CSI reporting of at least one of a set of joint-TRP CSI; and
at least one codepoint reserved to indicate omission of CSI reporting of at least one of a set of joint-TRP CSI.

27. (canceled)

28. The WD of claim 21, wherein the indication is included in a rank indicator field including bits reserved for reporting rank indications for single-TRP CSI reporting and joint-TRP CSI reporting.

29. The WD of claim 28, wherein a first rank is indicated for single-TRP CSI reporting and a second rank is indicated for joint-TRP CSI reporting.

30. The WD of claim 21, wherein joint-TRP CSI reporting is omitted when a rank indication exceeds a rank threshold.
